(19) United States
(12) Patent Application Publication
(10) Pub. No.: US 2010/0228886 A1
(43) Pub. Date: Sep. 9, 2010

(54) METHOD AND SYSTEM USING RANGE BANDWIDTH FOR CONTROLLING DISK I/O

(76) Inventors: Dong Jae Kang, Daejeon (KR); Chei Yol Kim, Daejeon (KR); Sung In Jung, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/569,859

(22) Filed: Sep. 29, 2009

(30) Foreign Application Priority Data
Mar. 5, 2009 (KR) 10-2009-0018886

(51) Int. Cl. G06F 3/00

(52) U.S. Cl. 710/6; 710/18; 710/58

(57) ABSTRACT

Provided are a method and a system for controlling a disk input/output (I/O). The method includes detecting the number of consumed tokens that are the processing units of the disk I/O. Also, the method includes assigning a time slice that is a duration for processing the disk I/O according to the number of the consumed tokens using a preset minimum disk I/O bandwidth and a preset maximum disk I/O bandwidth.

### CROSS-REFERENCE TO RELATED APPLICATIONS

This application claims priority under 35 U.S.C. §119 to Korean Patent Application No. 10-2009-0018886, filed on Mar. 5, 2009, in the Korean Intellectual Property Office, the disclosure of which is incorporated herein by reference in its entirety.

### TECHNICAL FIELD

The following disclosure relates to a method and a system for controlling disk input/output (I/O) providing a range bandwidth, and in particular, to a method and a system for controlling disk I/O providing an I/O range bandwidth for processing disk I/O based on the disk I/O minimum and maximum bandwidths preset for each process or each process group.

### BACKGROUND

In a related-art method for controlling disk I/O for each process or each process group, weight is assigned according to the importance of each process or each process group. Here, a greater I/O bandwidth is assigned to a process or a process group having greater importance than a process or a process group having less importance.

However, this method has a limitation in that it is difficult to estimate how much I/O bandwidth will be assigned according to the weight of each process or process group.

For another example, there is a method of proportionately assigning an I/O bandwidth according to the importance of each process or process group. However, this method also has a limitation in that it is difficult to know the I/O bandwidth to be assigned to each process or process group. Furthermore, the assigned bandwidth tends to vary according to the specifications of a disk I/O system, which is required to ensure disk I/O performance and Quality of Service (QoS), and may thus adversely affect the disk I/O system.

### SUMMARY

In one general aspect, a method for controlling a disk input/output (I/O) includes: detecting the number of consumed tokens that are the processing units of the disk I/O; and assigning a time slice that is a duration for processing the disk I/O according to the number of the consumed tokens using a preset minimum disk I/O bandwidth and a preset maximum disk I/O bandwidth.

In another general aspect, a method for controlling disk I/Os requested by a plurality of processes or process groups includes: detecting the number of consumed tokens that are processing units of the disk I/Os for each process or process group; and assigning a time slice that is a duration for processing the disk I/O for each process or process group in a determined order between the plurality of processes or process groups when there is a process or process group for which the number of the consumed tokens does not exceed the minimum number of I/O tokens corresponding to a minimum disk I/O bandwidth preset for the process or process group.

In still another general aspect, a system for controlling disk I/Os requested by a plurality of processes or process groups includes: a determination unit determining whether the number of consumed tokens that are processing units of the disk I/Os does not exceed the minimum number of I/O tokens corresponding to a minimum disk I/O bandwidth preset for the process or process group; and a time slice unit assigning a time slice that is a duration for processing the disk I/Os for each process or process group in a determined order between the plurality of processes or process groups if the number of the consumed tokens does not exceed the minimum number of the I/O tokens.

Other features and aspects will be apparent from the following detailed description, the drawings, and the claims.

### BRIEF DESCRIPTION OF THE DRAWINGS

FIG. 1 is a flowchart illustrating a method for controlling disk input/output (I/O) according to an exemplary embodiment.

FIG. 2 is a diagram illustrating a change of a local I/O mode by associating a method for controlling disk I/O according to an exemplary embodiment with the local I/O mode.

FIG. 3 is a flowchart illustrating a method for controlling disk I/O according to another exemplary embodiment.

FIG. 4 is a diagram illustrating a change of a global I/O mode by associating a method for controlling disk I/O according to another exemplary embodiment with the global I/O mode.

FIG. 5 is a diagram illustrating a system for controlling disk I/O according to anther exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Also, a process group may refer to processes related to each other in jobs for supporting specific services, or processes having requirements that need to be performed under the same management policy.

Hereinafter, exemplary embodiments will be described in detail with reference to the accompanying drawings

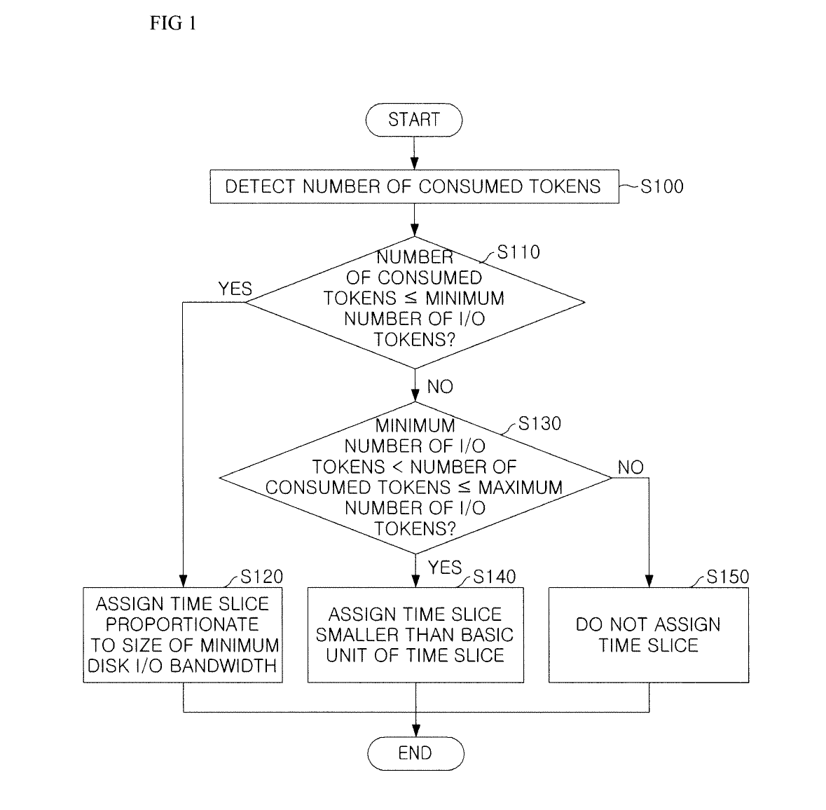

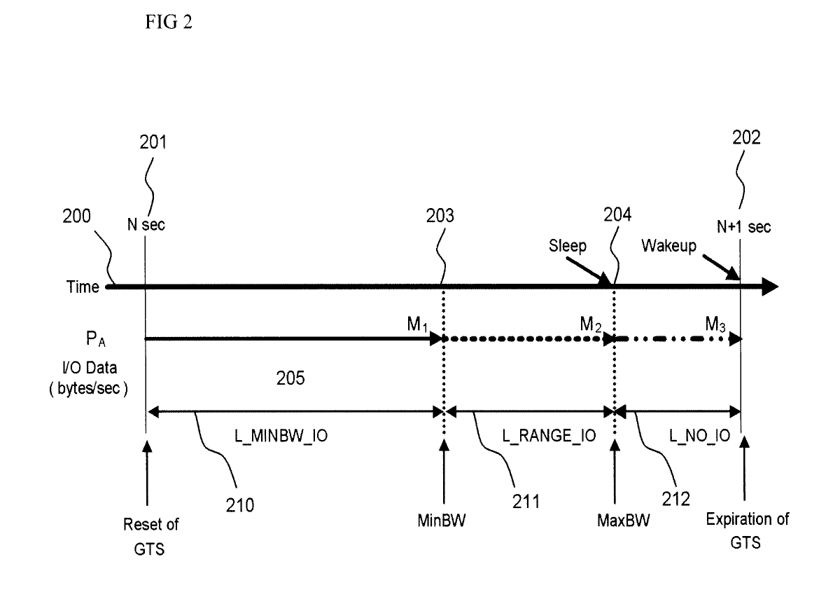

A method for controlling a disk input/output (I/O) according to an exemplary embodiment will be described with reference to FIGS. 1 and 2.

FIG. 1 is a flowchart illustrating a method for controlling disk I/O according to an exemplary embodiment. FIG. 2 is a diagram illustrating a change of a local I/O mode by associating a method for controlling disk I/O according to an exemplary embodiment with the local I/O mode.

As described in FIG. 1, in operation S100, a disk I/O scheduler controlling disk I/O detects the number of consumed tokens that is a processing unit of a disk I/O to process the disk I/O. That is, the disk I/O scheduler detects how many tokens were used to process a disk I/O requested by a process or a process group.

For example, when an I/O bandwidth assigned to a process or a process group is about 40 MBps, and one token is consumed for 512 bytes, then the number of tokens that may be consumed in the disk I/O per second may be about 81,920. The disk I/O scheduler may subtract the number of tokens (for example, 40,960) according to performed I/O (for example, 20M bytes) from the total number of tokens (for example, 81,920) assigned to a process or a process group, and detect the number of the consumed tokens using the remaining quantity of tokens (for example, 40,960).

The disk I/O scheduler assigns a time slice that is a duration for processing of the disk I/O according to the number of consumed tokens, based on a minimum disk I/O bandwidth (for example, 40 MBps) and a maximum disk I/O bandwidth (for example, 80 MBps) preset according to the importance of a process or a process group by a system administrator.

Here, the minimum disk I/O bandwidth is a minimum I/O bandwidth for ensuring QoS of a service that the process or the process group perform, and may imply a necessary I/O bandwidth. The maximum disk I/O bandwidth is an I/O bandwidth that must not be exceeded in processing a disk I/O requested by a process or a process group, and may imply a restricted I/O bandwidth.

A method of assigning a time slice according to the number of consumed tokens by the disk I/O scheduler using the preset minimum disk I/O bandwidth and the preset maximum disk I/O bandwidth will be outlined below.

In operation S110, when the number of consumed tokens is smaller than or identical to the minimum number of the I/O tokens (81,920) corresponding to the minimum disk I/O bandwidth (40 MBps), the disk I/O scheduler may assign a time slice proportionate to the size of the minimum disk I/O bandwidth (for example, the minimum number of I/O tokens) to process the disk I/O in operation S120.

Here, the proportionate time slice is expressed as below:

Proportionate Time Slice=Basic Unit of Time Slice+{Basic Unit of Time Slice*(Minimum number of I/O tokens/Total Number of Available Tokens)}

The total number of available tokens may refer to the number of all tokens that are assigned to process a disk I/O for each process or process group when at least two processes or the process groups request the disk I/O. The available tokens may be used to process only a disk I/O requested by a specific process or process group.

The proportionate time slice may be assigned much more frequently during processing of a disk I/O for a process or a process group having a greater minimum bandwidth than for a process or a process group having a smaller minimum bandwidth.

In operation S130, when the number of consumed tokens is greater than the minimum number of the I/O tokens (81,290) corresponding to the minimum disk I/O bandwidth (40 MBps) and less than or identical to the maximum number of the I/O tokens (163,840) corresponding to the maximum disk I/O bandwidth (80 MBps), the disk I/O scheduler may assign time slice less (for example, when the basic unit of the time slice is from 20 to 25 ticks, (basic unit of time slice)/5) in operation S140.

That is, when the number of consumed tokens is greater than the minimum number of the I/O tokens (81,290) corresponding to the minimum disk I/O bandwidth (40 MBps) and less than or identical to the maximum number of the I/O tokens (163,840) corresponding to the maximum disk I/O bandwidth (80 MBps), the disk I/O scheduler may assign a time slice (from 4 to 5 ticks) that is less than the basic unit of a time slice (from 20 to 25 ticks) preset when the disk I/O on a process or a process group is processed. Here, the reduced time slice (from 16 to 20 ticks) may be assigned for a disk I/O for other processes or process groups.

When the number of consumed tokens is greater than the maximum number of the I/O tokens (163,840) corresponding to the maximum disk I/O bandwidth (80 MBps), in operation S150, the disk I/O scheduler may not assign a time slice.

That is, when the number of consumed tokens is greater than the maximum number of the I/O tokens (163,840) corresponding to the maximum disk I/O bandwidth (80 MBps), the time slice that are not assigned to the corresponding process or process group may be assigned for a disk I/O processing requested by another process or process group.

As described above, the disk I/O scheduler can efficiently use the restricted disk I/O bandwidth by assigning fewer time slices for a disk I/O processing requested by other process or process group when more time slices are assigned for a disk I/O processing requested by a specific process or process group, and provide an expectable I/O bandwidth for each process or process group.

Hereinafter, the method for controlling disk I/O as described above will be described in detail with reference to FIG. 2.

FIG. 2 illustrates a change of a local I/O mode corresponding to the number of tokens consumed according to the lapse of processing time when a disk I/O scheduler processes a disk I/O requested by a process or a process group PA for one second from N sec to N+1 sec.

As illustrated in FIG. 2, the local I/O mode shows a processed state of a disk I/O requested by a process or a process group (for example, PA). The local I/O mode is divided into an L_MINBW_IO mode 210, an L_RANGE_IO mode 211, and an L_NO_IO mode 212.

The I/O mode repeats the same pattern, for example, is maintained in the L_MINBW_IO mode 210, or is changed from the L_MINBW_IO mode 210 to the L_RANGE_IO mode 211, or from the L_RANGE_IO mode 211 to the L_NO_IO mode 212 every second. That is, the above maintenance or change is repeated every second.

An initializing operation on a time slice of all processes or process groups participating in the I/O, the number of consumed tokens, and I/O mode is performed at the start point 201 or the end point 202 of every second.

The local I/O mode is the L_MINBW_IO mode 210 when the number of consumed tokens is less than or identical to the minimum number of the I/O tokens (81,920) corresponding to a minimum disk I/O bandwidth (40 MBps). The disk I/O scheduler may assign a time slice proportionate to the size of the minimum disk I/O bandwidth (for example, the minimum number of the I/O tokens) to process a disk I/O requested by a process or a process group PA in the L_MINBW_IO mode 210.

The local I/O mode is the L_RANGE_IO mode 211 when the number of consumed tokens is more than the minimum number of the I/O tokens (81,920) corresponding to the minimum disk I/O bandwidth (40 MBps), and less than or identical to the maximum number of the I/O tokens (163,840) corresponding to the maximum disk I/O bandwidth (80 MBps). The disk I/O scheduler may assign a reduced time slice (for example, when the basic unit of the time slice is from 20 to 25 ticks, (basic unit of time slice)/5) to process a disk I/O requested by a process or a process group PA in the L_RANGE_IO mode 211.

The local I/O mode is the L_NO_IO mode 212 when the number of consumed tokens is more than the maximum number of the I/O tokens (163,840) corresponding to the maximum disk I/O bandwidth (80 MBps). The disk I/O scheduler may not assign a time slice for a disk I/O processing requested by a process or a process group PA in the L_NO_IO mode 212.

The local I/O mode at the start point of the disk I/O processing may be the L_MINBW_IO mode 210.

When a disk I/O processing time is at or before the point of the MinBW 203, that is, the disk I/O processing time is less than M1, the local I/O mode is the L_MINBW_IO 210. In this case, the disk I/O scheduler may assign a time slice proportionate to the size of the minimum disk I/O bandwidth (for example, the minimum number of the I/O tokens).

When the disk I/O processing time is between the MinBW 203 and the MaxBW 204, that is, the disk I/O processing time is between M1 and M2, the local I/O mode is a L_RANGE_IO mode 211. In this case, the disk I/O scheduler may assign a reduced time slice (for example, when the basic unit of the time slice is from 20 to 25 ticks, (basic unit of time slice)/5) in the L_RANGE_IO mode 211.

When the disk I/O processing time is beyond the MaxBW 204, that is, the disk I/O processing time is between M2 and M3, the local I/O mode is a L_NO_IO mode 212. In this case, the disk I/O scheduler may not assign a time slice.

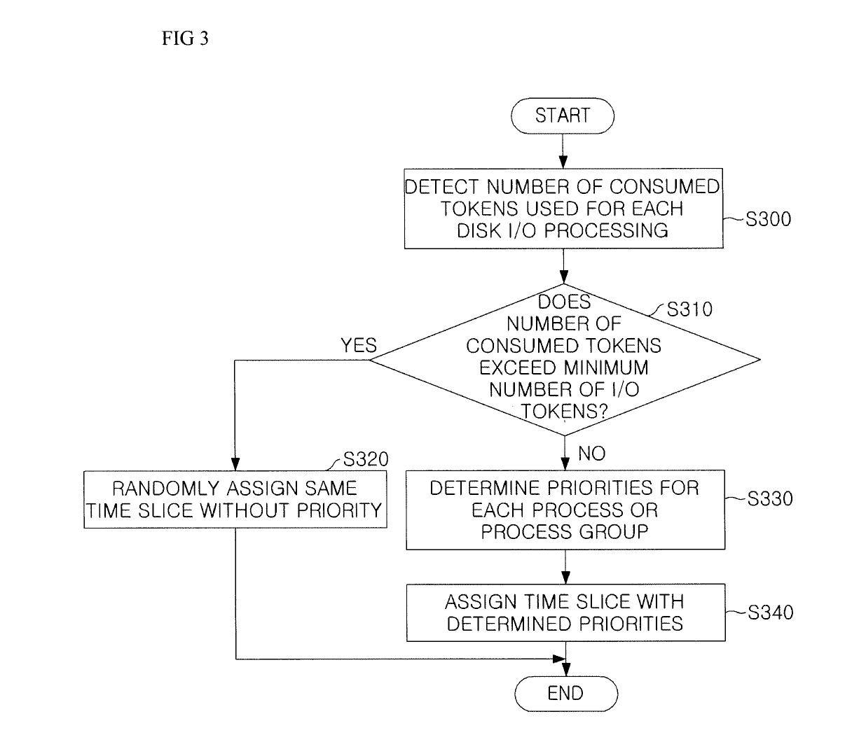

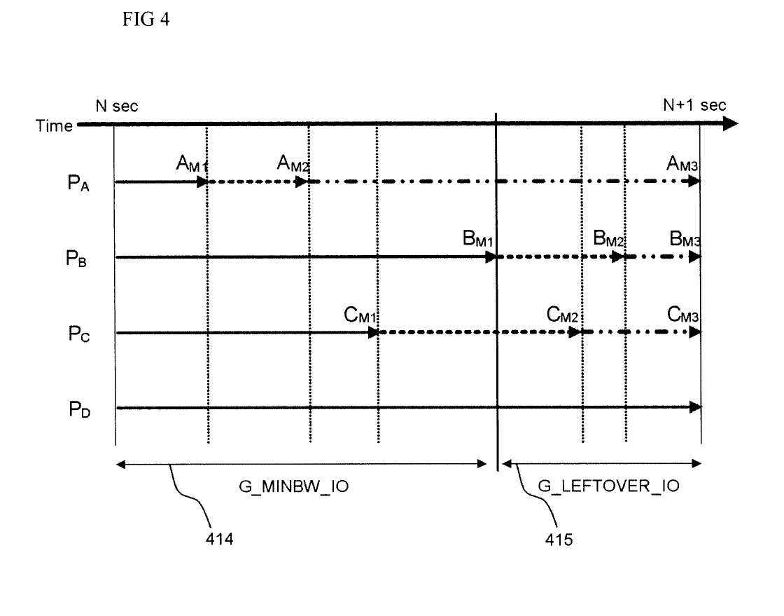

Hereinafter, a method for controlling disk I/O according to another embodiment will be described in detail with reference to FIGS. 3 and 4.

FIG. 3 is a flowchart illustrating a method for controlling disk I/O according to another exemplary embodiment. FIG. 4 is a diagram illustrating a change of a global I/O mode by associating a method for controlling disk I/O according to another exemplary embodiment with the global I/O mode.

As described in FIG. 3, in operation S300, a disk I/O scheduler for controlling disk I/Os requested by a plurality of processes or process groups detects the number of tokens (for example, the number of used tokens) consumed in a disk I/O processing for each process or process group.

In operation S310, the disk I/O scheduler determines whether the number of consumed tokens detected in each process or process group exceed the minimum number of the I/O tokens corresponding to the minimum disk I/O bandwidth preset for each process or process group.

In operation S320, if the number of the consumed tokens exceeds the minimum number of the I/O tokens, the disk I/O scheduler assigns a time slice for each process or process group without a determined order, i.e., priority.

That is, the disk I/O scheduler may randomly assign an identical time slice for each process or process group.

In operation S330, if there is at least one process or process group that does not exceed, the disk I/O scheduler determines an order to assign a discriminative time slice between the plurality of processes or process groups.

The disk I/O scheduler may assign highest priority to a process or a process group for which the number of consumed tokens does not exceed the minimum number of the I/O tokens, and assign second priority to a process or a process group for which the minimum disk I/O bandwidth is not set. The disk I/O scheduler may assign third priority to a process or a process group for which the number of consumed tokens exceeds the minimum number of the I/O tokens, and assign fourth priority to a process or a process group for which the number of the consumed tokens exceeds the maximum number of the I/O tokens corresponding to the maximum disk I/O bandwidth preset for each process or process group.

The disk I/O scheduler may assign a higher priority to a process or process group having a greater minimum disk I/O bandwidth among processes or process groups that do not meet the minimum disk I/O bandwidth.

In operation S340, the disk I/O scheduler assigns a time slice in the order determined as described above.

Upon assignment of the time slice, the disk I/O scheduler may assign a time slice proportionate to the size of the minimum disk I/O bandwidth when the number of the consumed tokens is smaller than or identical to the number of the minimum I/O token number.

When the number of the consumed tokens is greater than the minimum number of the I/O tokens, and smaller than or identical to the maximum I/O token number corresponding to the maximum disk I/O bandwidth, the disk I/O scheduler may assign a time slice smaller than a preset basic unit of the time slice.

When the number of the consumed tokens is greater than the maximum number of the I/O tokens, the disk I/O scheduler may not assign a time slice.

That is, when an increased time slice is assigned for an disk I/O processing requested by a specific process or process group having a high priority, a time slice for a disk I/O processing requested by a process or process group having a low priority is reduced by the increased amount of the time slice for the disk I/O processing requested by the specific process or process group having a high priority. Accordingly, a restricted disk I/O bandwidth may be efficiently used. Also, since an expectable I/O bandwidth for a disk I/O processing requested by each process or process group can be provided, the performance and quality of the disk I/O service can be ensured.

Hereinafter, the method for controlling disk I/Os requested by a plurality of processes or process groups according to another embodiment as described above will be more fully described with reference to FIG. 4.

FIG. 4 illustrates a change of a global I/O mode corresponding to the number of consumed tokens according to the lapse of the processing time when a disk I/O scheduler processes disk I/Os requested by a plurality of processes or process groups (for example, PA, PB, PC, and PD).

As illustrated in FIG. 4, the global I/O mode is divided into a G_MINBW_IO mode 414 and a G_LEFTOVER_IO mode 415 according to whether a process or a process group for which the number of the consumed token does not exceed the minimum number of the I/O tokens corresponding to a minimum disk I/O bandwidth preset for each process or process group exists or not.

That is, the global I/O mode is the G_MINBW_IO mode 414 when there is a process or a process group that does not meet the minimum bandwidth. The global I/O mode is a G_LEFTOVER_IO mode 415 when all processes or process groups meets the minimum bandwidth.

An I/O processing method of the G_MINBW_IO mode 414 will be described as below.

When the global I/O mode is the G_MINBW_IO 414, the local I/O mode of each process or process group (PA, PB, PC, and PD) may be one of the L_MINBW_IO mode 210, the L_RANGE_IO mode 211, and the L_NO_IO mode 212 as described in FIG. 2.

For example, if the local I/O mode for each processes or process groups PA, PB, PC and PD is the L_MINBW_IO mode 210, then the disk I/O processing time of the process or process group PA is before AMI, the disk I/O processing time of the process or process group PB is before BM1, and the disk I/O processing time of the process or process group PC is before CM1. The local I/O mode for the process or process group PD is not changed because the minimum disk I/O bandwidth and the maximum bandwidth are not set.

A time slice to be assigned according to the local I/O mode is set for each process or process group PA, PB, PC and PD. When the global I/O mode is the G_MINBW mode 414, the disk I/O scheduler may determine the priorities of assigning time slices for each process or process group.

The disk I/O scheduler may determine the priorities of the time slice assignment in the order of the case where the number of consumed tokens does not exceed the size of the minimum disk I/O bandwidth (for example, the minimum number of the I/O tokens)>the case where the minimum bandwidth is not set>the case where the number of the consumed tokens exceeds the size of the minimum disk I/O bandwidth>the case where the number of the consumed tokens exceeds the size of the maximum disk I/O bandwidth.

If there are processes or process groups for which the number of the consumed tokens does not exceed the size of the minimum bandwidth, the disk I/O scheduler may assign a higher priority to a process or process group having a greater minimum bandwidth.

For example, at the point AM2 where the local I/O mode of the process or process group PA is the L_RANGE_IO mode 211, the local I/O mode of the process or process group PB is the L_MINBW_IO mode 210, the local I/O mode of the process or process group PC is the L_MINBW_IO mode 210, and the minimum and maximum disk I/O bandwidths are not set for the process or process group PD, the processes or process groups PB and PC have the first priorities. Next, the process or process group PD has the second priority, and the process or process group PA has the third priority.

In this case, the processes or process group PB and PC having the same priority may be re-prioritized according to the size of the minimum disk I/O bandwidth. Since the process or process group PB has a greater minimum disk I/O bandwidth than the process or process group PC, the process or process group PB has the highest priority.

If the processing time of a disk I/O requested by the process or process group PB lapses BM1, the number of the consumed tokens for all processes or process groups exceeds the minimum number of the I/O tokens, thereby changing the global I/O mode into the G_LEFTOVER_IO mode 415.

If the global I/O mode is the G_LEFTOVER_IO mode 415, the priorities for each process or process group are not set.

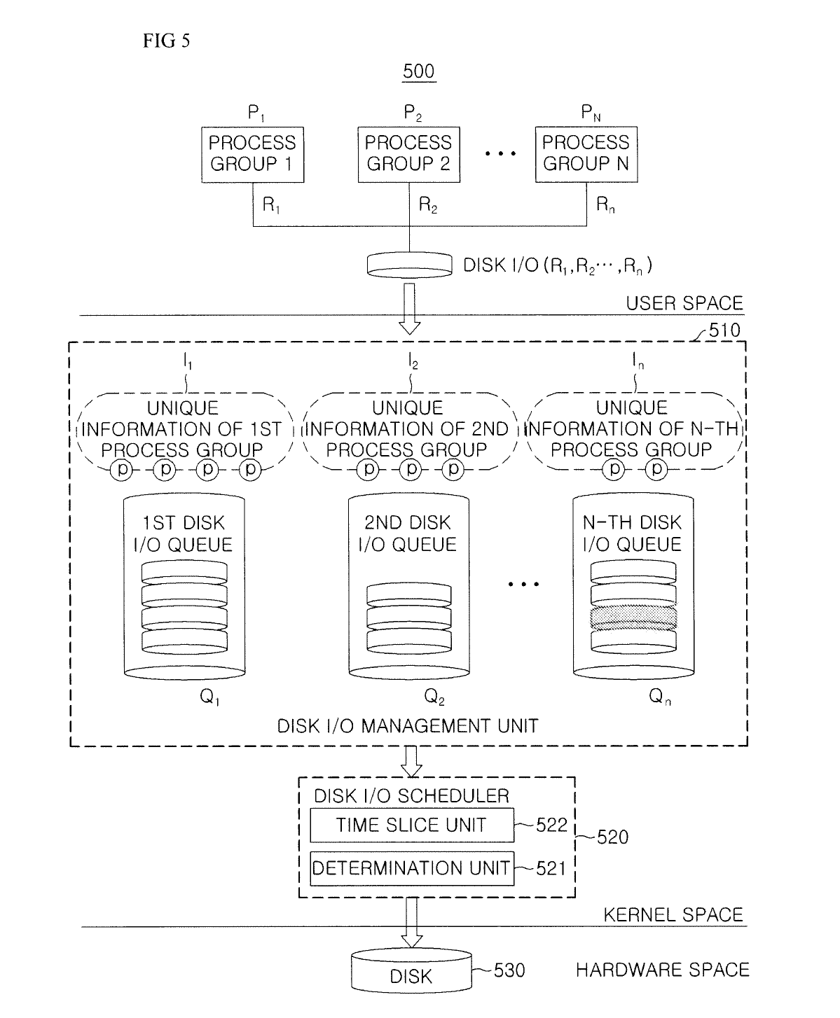

Hereinafter, a system for controlling disk I/O according to another exemplary embodiment will be described with reference to FIG. 5.

FIG. 5 is a diagram illustrating a system for controlling disk I/O according to anther exemplary embodiment.

As illustrated in FIG. 5, a system 500 for controlling disk I/O includes a disk I/O management unit 510 and a disk I/O scheduler 520.

The disk I/O management unit 510 distinguishes and manages disk I/Os R1, R2, . . . , Rn requested by a plurality of processes or process groups P1, P2, . . . , Pn.

For example, the disk I/O management unit 510 may maintain disk I/O queues Q1, Q2, . . . , Qn for each process or process group P1, P2, . . . , Pn. Also, the disk I/O management unit 510 may compare identifiers in each disk I/O R1, R2, . . . , Rn and unique information I1, I2, . . . , In of each process or process group P1, P2, . . . , Pn, and input a disk I/O R1, R2, . . . , Rn into a disk I/O queue corresponding to matching unique information I1, I2, . . . , In.

The disk I/O scheduler 520 includes a determination unit 521 and a time slice unit 522. The disk I/O scheduler 520 processes each disk I/O R1, R2, . . . , Rn inputted into each disk I/O queue Q1, Q2, . . . , Qn.

The disk I/O scheduler 520 processes each disk I/O R1, R2, . . . , Rn using the minimum and maximum disk I/O bandwidths for each process or process group P1, P2, . . . , Pn preset by a system administrator based on the importance for each process or process group.

The determination unit 521 determines whether the number of tokens (the processing unit of the disk I/O) consumed to control the disk I/O between the plurality of processes or process groups does not exceed the minimum number of the I/O tokens corresponding to the minimum disk I/O bandwidth preset for each process or process group P1, P2, . . . , Pn.

When the number of the consumed tokens does not exceed the minimum number of the I/O tokens corresponding to the minimum disk I/O bandwidth preset for each process or process group P1, P2, . . . , Pn, the determination unit 521 determines the order of assigning time slices for each process or process group.

For example, the determination unit 521 may assign highest priority to a process or process group for which the number of the consumed tokens does not exceed the minimum number of the I/O tokens.

The determination unit 521 may assign second priority to a process or process group for which a minimum disk I/O bandwidth is not set, assign third priority to a process or process group for which the number of the consumed tokens exceeds the minimum number of the I/O tokens, and assign fourth priority to a process or process group for which the number of the consumed tokens exceeds the maximum number of the I/O tokens corresponding to a maximum disk I/O bandwidth preset for each process or process group.

If there are a plurality of processes or process groups (for example, P1 and P2) having the same priority, the determination unit 521 may assign a higher priority to a process or process group (for example, P1 when P1 has a greater minimum disk I/O bandwidth) having a greater minimum disk I/O bandwidth.

If the number of the consumed tokens for all processes or process groups P1, P2, . . . , Pn exceeds the maximum number of the I/O tokens corresponding to the maximum disk I/O bandwidth preset for each process or process group P1, P2, . . . , Pn, the order of assigning time slices for each process or process group P1, P2, . . . , Pn is not determined.

The time slice unit 522 assigns time slices that are durations for processing disk I/Os R1, R2, . . . , Rn in the determined order for each process or process group.

If the number of the consumed tokens is smaller than or identical to the minimum number of the I/O tokens, the time slice unit 522 may assign a time slice proportionate to the size of the minimum disk I/O bandwidth.

If the number of the consumed tokens is more than the minimum number of the I/O tokens, and less than or identical to the maximum number of the I/O tokens corresponding to the maximum disk I/O bandwidth, the time slice unit 522 may assign a reduced time slice (for example, (20 to 25)/5 when the basic time slice is from 20 to 25 ticks). If the number of the consumed tokens is more than the maximum number of the I/O tokens, the time slice unit 522 may not assign the time slice.

Thus, the time slice unit 522 may assign more time slices to a process or process group having a higher priority than a process or process group having a lower priority.

When there is no determined priority, the time slice unit 522 may randomly assign the same time slice for each process or process group P1, P2, . . . , Pn.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for controlling a disk input/output (I/O), comprising:
detecting the number of consumed tokens that are the processing units of the disk I/O; and
assigning a time slice that is a duration for processing the disk I/O according to the number of the consumed tokens using a preset minimum disk I/O bandwidth and a preset maximum disk I/O bandwidth.

2. The method of claim 1, wherein the assigning of a time slice comprises assigning a time slice proportionate to the size of the minimum disk I/O bandwidth when the number of the consumed tokens is smaller than or identical to the minimum number of the I/O tokens corresponding to the minimum disk I/O bandwidth.

3. The method of claim 1, wherein the assigning of a time slice comprises assigning a reduced time slice when the number of the consumed tokens is greater than the minimum number of the I/O tokens corresponding to the minimum disk I/O bandwidth, and smaller than or identical to the maximum number of the I/O tokens corresponding to the maximum disk I/O bandwidth.

4. The method of claim 1, wherein, in the assigning of a time slice, the time slice is not assigned when the number of the consumed tokens is greater than the maximum number of the I/O tokens corresponding to the maximum disk I/O bandwidth.

5. The method of claim 1, wherein the assigning of a time slice comprises:
assigning the time slice assigned to a processing of the disk I/O requested by a second process or process group to a processing of the disk I/O requested by a first process or process group when the number of the consumed tokens is smaller than or identical to the minimum number of the I/O tokens corresponding to the minimum disk I/O bandwidth; and
assigning the time slice assigned to the processing of the disk I/O requested by the first process or process group to the processing of the disk I/O requested by the second process or process group when the number of the consumed tokens is greater than the minimum number of the I/O tokens corresponding to the minimum disk I/O bandwidth.

6. A method for controlling disk I/Os requested by a plurality of processes or process groups, the method comprising:
detecting the number of consumed tokens that are processing units of the disk I/Os for each process or process group; and
assigning a time slice that is a duration for processing the disk I/O for each process or process group in a determined order between the plurality of processes or process groups when there is a process or process group for which the number of the consumed tokens does not exceed the minimum number of I/O tokens corresponding to a minimum disk I/O bandwidth preset for the process or process group.

7. The method of claim 6, wherein the assigning of a time slice comprises:
assigning the time slice with first priority to a process or process group for which the number of the consumed tokens does not exceed the minimum number of the I/O tokens;
assigning the time slice with second priority to a process or process group for which the minimum disk I/O bandwidth is not set;
assigning the time slice with third priority to a process or process group for which the number of the consumed tokens exceeds the minimum number of the I/O tokens; and
assigning the time slice with fourth priority to a process or process group for which the number of the consumed tokens exceeds the maximum number of I/O tokens corresponding to a maximum disk I/O bandwidth preset for the process or process.

8. The method of claim 7, wherein the assigning of a time slice further comprises preferentially assigning the time slice to a process or process group having a greater minimum disk I/O bandwidth if a plurality of processes or process groups have the same order.

9. The method of claim 7, wherein the assigning of a time slice comprises assigning an increased time slice to a processing of the disk I/O for a process or process group having a higher priority by a time slice reduced for a processing of the disk I/O for a process or process group having a lower priority.

10. The method of claim 6, wherein the assigning of a time slice comprises:
assigning a time slice proportionate to the size of the minimum disk I/O bandwidth when the number of the consumed tokens is smaller than or identical to the minimum number of the I/O tokens;
assigning a reduced time slice when the number of the consumed tokes is greater than the minimum number of the I/O tokens, and is smaller than or identical to the maximum number of the I/O tokens corresponding to the maximum disk I/O bandwidth; and
non-assigning the time slice when the number of the consumed tokens is greater than the maximum number of the I/O tokens.

11. The method of claim 6, further comprising assigning the time slice for each process or process group regardless of the determined order when the number of the consumed tokens of all the process or process groups exceeds the number of the maximum tokens corresponding to the maximum disk I/O bandwidth preset for the process or process group.

12. The method of claim 11, wherein the assigning of the time slice for each process or process group regardless of the determined order comprises randomly assigning the same time slice for each process or process group.

13. A system for controlling disk I/Os requested by a plurality of processes or process groups, the system comprising:
a determination unit determining whether the number of consumed tokens that are processing units of the disk I/Os does not exceed the minimum number of I/O tokens corresponding to a minimum disk I/O bandwidth preset for the process or process group; and
a time slice unit assigning a time slice that is a duration for processing the disk I/Os for each process or process group in a determined order between the plurality of processes or process groups if the number of the consumed tokens does not exceed the minimum number of the I/O tokens.

14. The system of claim 13, wherein the determination unit
assigns highest priority to a process or process group for which the number of the consumed tokens does not exceed the minimum number of the I/O tokens;
assigns second priority to a process or process group for which the minimum disk I/O bandwidth is not set;
assigns third priority to a process or process group for which the number of the consumed tokens exceeds the minimum number of the I/O tokens; and
assigns fourth priority to a process or process group for which the number of the consumed tokens exceeds the maximum number of I/O tokens corresponding to a maximum disk I/O bandwidth preset for the process or process.

15. The system of claim 14, wherein the determination unit assigns a higher priority to a process or process group having a greater minimum disk I/O bandwidth if a plurality of processes or process groups have the same order.

16. The system of claim 14, wherein the time slice unit assigns a time slice assigned to a process or process group having a lower priority to a process or process group having a higher priority.

17. The system of claim 14, wherein the time slice unit
assigns a time slice proportionate to the size of the minimum disk I/O bandwidth when the number of the consumed tokens is smaller than or identical to the minimum number of the I/O tokens;
assigns a smaller time slice than a basic unit of the preset time slice when the number of the consumed tokes is greater than the minimum number of the I/O tokens, and is smaller than or identical to the maximum number of the I/O tokens corresponding to the maximum disk I/O bandwidth; and
does not assign the time slice when the number of the consumed tokens is greater than the maximum number of the I/O tokens.

18. The system of claim 13, wherein the determination unit does not determine the order of assigning the time slice when the number of the consumed tokens of all the process or process groups exceeds the number of the maximum tokens corresponding to the maximum disk I/O bandwidth preset for the process or process group.

19. The system of claim 18, wherein the time slice unit randomly assigns the same time slice for each process or process group.

20. The system of claim 13, further comprising a disk I/O management unit distinguishes and manages the disk I/Os for each process or process group, the disk I/O management unit managing a disk I/O queue for each process or process group and inputting the disk I/Os into the disk I/O queue corresponding to an identifier comprised in the disk I/O to distinguish the process or process group.
